(19) United States
(12) Patent Application Publication
(10) Pub. No.: US 2025/0141254 A1
(43) Pub. Date: May 1, 2025

(54) PARALLEL CONTROL METHOD FOR MULTIPLE BATTERY PACKS AND BATTERY MANAGEMENT SYSTEM

(71) Applicant: Hulkman Innovation Technology (Shenzhen) Co., Ltd., Shenzhen (CN)

(72) Inventors: Jun Yang, Shenzhen (CN); Xuewen Peng, Shenzhen (CN)

(21) Appl. No.: 18/530,521

(22) Filed: Dec. 6, 2023

(30) Foreign Application Priority Data
Oct. 25, 2023 (CN) 202311394529.1

(51) Int. Cl. H02J 7/00; H01M 10/42; H01M 10/44; H01M 50/512

(52) U.S. Cl. CPC H02J 7/00712; H01M 10/425; H01M 10/441; H01M 50/512; H02J 7/0014; H02J 7/00304; H02J 7/0047; H01M 2010/4271

(57) ABSTRACT

A parallel control method for multiple battery packs includes: in response to the multi-battery pack system being in a charging state, acquiring real-time voltages of the battery packs in the multi-battery pack system; determining a first battery pack and a second battery pack based on the real-time voltages, wherein a voltage of the first battery pack is a minimum voltage in the real-time voltages, and a voltage of the second battery pack is a second minimum voltage in the real-time voltages; controlling the first battery pack to be charged; and in response to the voltage of the first battery pack and the voltage of the second battery pack satisfying a predetermined charging condition, controlling the first battery pack and the second battery pack to be simultaneously charged, and analogously continuing such control until the all the battery packs in the multi-battery pack system are simultaneously charged.

### CROSS-REFERENCE TO RELATED APPLICATIONS

This application is based upon and claims priority to Chinese Patent Application No. 202311394529.1, filed before China National Intellectual Property Administration on Oct. 25, 2023 and entitled “PARALLEL CONTROL METHOD FOR MULTIPLE BATTERY PACKS, BATTERY MANAGEMENT SYSTEM, AND STORAGE MEDIUM,” the entire content of which is incorporated herein by reference.

### TECHNICAL FIELD

The present disclosure relates to the technical field of batteries connected in parallel, and in particular, relates to a parallel control method for multiple battery packs and a battery management system.

### BACKGROUND

A multi-battery pack system typically includes a primary battery pack and a plurality of secondary battery packs that are connected in parallel. A new secondary battery pack may be inserted to an original multi-battery pack system and connected in parallel to the original multi-battery pack system, and communication may be established therebetween to form a new multi-battery pack system.

### SUMMARY

In a first aspect, various embodiments of the present disclosure disclose a parallel control method for multiple battery packs, applicable to a multi-battery pack system. Battery packs in the multi-battery pack system are connected in parallel. The method includes:
in response to the multi-battery pack system being in a charging state, acquiring real-time voltages of the battery packs in the multi-battery pack system;
determining a first battery pack and a second battery pack based on the real-time voltages, wherein a voltage of the first battery pack is a minimum voltage in the real-time voltages, and a voltage of the second battery pack is a second minimum voltage in the real-time voltages;
controlling the first battery pack to be charged; and
in response to the voltage of the first battery pack and the voltage of the second battery pack satisfying a predetermined charging condition, controlling the first battery pack and the second battery pack to be simultaneously charged, and analogously continuing such control until the all the battery packs in the multi-battery pack system are simultaneously charged.

In some embodiments, the predetermined charging condition includes:
a first difference between the voltage of the first battery pack and the voltage of the second battery pack being less than or equal to a first predetermined threshold.

In some embodiments, the step of controlling the first battery pack and the second battery pack to be simultaneously charged includes:
acquiring a first requested charging current of the first battery pack and a second requested charging current of the second battery pack;
simultaneously charging the first battery pack and the second battery pack using an input current, wherein the input current is a sum of the first requested charging current and the second requested charging current;
acquiring a first actual charging current of the first battery pack and a second actual charging current of the second battery pack; and
regulating the input current based on the first actual charging current, the second actual charging current, the first requested charging current, and the second requested charging current.

In some embodiments, the step of regulating the input current based on the first actual charging current, the second actual charging current, the first requested charging current, and the second requested charging current includes:
determining whether the first actual charging current, the second actual charging current, the first requested charging current, and the second requested charging current satisfy an over current protection condition; and
reducing the input current in response to the over current protection condition being not satisfied.

In some embodiments, the over current protection condition includes:
the first actual charging current being less than or equal to the first requested charging current, and the second actual charging current being less than or equal to the second requested charging current.

In some embodiments, the step of controlling the first battery pack and the second battery pack to be simultaneously charged includes:
acquiring a first requested charging voltage of the first battery pack and a second requested charging voltage of the second battery pack; and
simultaneously charging the first battery pack and the second battery pack using an input voltage, wherein the input voltage is a minimum voltage of the first requested charging voltage and the second requested charging voltage.

In some embodiments, the method further includes:
in response to the multi-battery pack system being in a discharging state, acquiring a first discharging voltage and a second discharging voltage, wherein the first discharging voltage is a voltage of an original multi-battery pack system, and the second discharging voltage is a voltage of a newly inserted secondary battery pack; and
determining a target discharging voltage based on the first discharging voltage and the second discharging voltage, wherein the target discharging voltage is a supply voltage provided by the target discharging voltage to a load.

In some embodiments, the step of determining the target discharging voltage based on the first discharging voltage and the second discharging voltage includes:
calculating a second difference between the first discharging voltage and the second discharging voltage;
in response to the second difference being greater than a second predetermined threshold, cutting off a charging loop and a discharging loop of the newly inserted secondary battery pack, and determining the first discharging voltage as the target discharging voltage;
in response to the second difference being less than or equal to the second predetermined threshold and being greater than or equal to a third predetermined threshold, forming a target battery pack system using the original multi-battery pack system and the newly inserted secondary battery pack, and determining a voltage of the target battery pack system as the target discharging voltage; and
in response to the second difference being less than the third predetermined threshold, determining the second discharging voltage as the target discharging voltage.

In some embodiments, determining the second discharging voltage as the target discharging voltage includes:
cutting off a charging loop of the original multi-battery pack system;
connecting the newly inserted secondary battery pack to the system;
cutting off a discharging loop of the original multi-battery pack system; and
closing the discharging loop of the newly inserted secondary battery pack.

In some embodiments, the method further includes:
in response to a new secondary battery packet being inserted to the multi-battery pack system, identifying the newly inserted secondary battery pack; and
in response to successful identification, determining whether a charging current is input to a primary battery pack in the multi-battery pack system;
determining that the multi-battery pack system is in a charging state in response to the charging current being input to the primary battery pack; and
determining that the multi-battery pack system is in a discharging state in response to the charging current being not input to the primary battery pack.

In a second aspect, various embodiments of the present disclose provide a battery management system. The system includes:
at least one processor; and
a memory communicably connected to the at least one processor;
the memory stores instructions executable by the at least one processor, wherein, the instructions, when being executed by the at least one processor, cause the at least one processor to perform the parallel control method for multiple battery packs as described above.

In a third aspect, various embodiments of the present disclosure disclose a parallel control system for multiple battery packs, applicable to a multi-battery pack system. Battery packs in the multi-battery pack system are connected in parallel. The system includes the battery management system as described above.

### BRIEF DESCRIPTION OF THE DRAWINGS

One or more embodiments are illustrated by way of example, and not by limitation, in the accompanying drawings, wherein components having the same reference numeral designations represent like components throughout. The drawings are not to scale, unless otherwise disclosed.

FIG. 1 is a schematic diagram of an application scenario of a parallel control system for multiple battery packs according to an embodiment of the present disclosure;

FIG. 2 is a schematic diagram of a hardware structure of a battery management system according to an embodiment of the present disclosure;

FIG. 3 is a schematic flowchart of a parallel control method for multiple battery packs according to an embodiment of the present disclosure;

FIG. 4 is a schematic flowchart of step S34 in FIG. 3;

FIG. 5 is a schematic flowchart of a parallel control method for multiple battery packs according to an embodiment of the present disclosure;

FIG. 6 is a schematic flowchart of step S36 in FIGS. 5; and

FIG. 7 is a schematic structural diagram of a parallel control apparatus for battery packs according to an embodiment of the present disclosure.

### DETAILED DESCRIPTION

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure. Based on the embodiments of the present disclosure, all other embodiments derived by persons of ordinary skill in the art without any creative efforts shall fall within the protection scope of the present disclosure.

It should be noted that, in the absence of conflict, embodiments of the present disclosure and features in the embodiments may be incorporated, which all fall within the protection scope of the present disclosure. In addition, although logic function module division is illustrated in the schematic diagrams of apparatuses, and logic sequences are illustrated in the flowcharts, in some occasions, steps illustrated or described by using modules different from the module division in the apparatuses or in sequences different from those illustrated. Further, the terms “first,” “second,” and “third” used in this text do not limit data and execution sequences, and are intended to distinguish identical items or similar items having substantially the same functions and effects.

Referring to FIG. 1, FIG. 1 is a schematic diagram of an application scenario of a parallel control system for multiple battery packs according to an embodiment of the present disclosure. The parallel control system for multiple battery packs includes a battery management system (MBS) 100, and is applicable to a multi-battery pack system 200. The multi-battery pack system 200 includes a primary battery pack 21 and a plurality of secondary battery packs 22. The primary battery pack 21 and the plurality of secondary battery packs 22 are all connected in parallel. A new secondary battery pack may be inserted to an original battery pack system and connected to the original battery pack system in parallel, communication may be established therebetween to form a new multi-battery pack system. The primary battery pack 21 and the plurality of secondary battery packs 22 all include the battery management system 100. In the process that the new secondary battery pack is connected in parallel to the original multi-battery pack system, the battery management process 100 needs to control a charging or discharging process of the new multi-battery pack system to achieve parallel mixed use of batteries having different capacity levels, and thus charging and discharging effects are improved.

In the traditional parallel connection of multiple battery packs, the battery management system 100 controls the battery packs in the multi-battery pack system 200 to be sequentially charged. Consequently, the charging takes a long time, and a charging efficiency is low.

Based on the above, an embodiment of the present disclosure provides a parallel control method for multiple battery packs. The method includes: in response to the multi-battery pack system being in a charging state, acquiring real-time voltages of the battery packs in the multi-battery pack system; determining a first battery pack and a second battery pack based on the real-time voltages, wherein a voltage of the first battery pack is a minimum voltage in the real-time voltages, and a voltage of the second battery pack is a second minimum voltage in the real-time voltages; controlling the first battery pack to be charged, and acquiring a voltage of the first battery pack upon charging; and in response to the voltage of the first battery pack and the voltage of the second battery pack satisfying a predetermined charging condition, controlling the first battery pack and the second battery pack to be simultaneously charged, and analogously continuing such control until the all the battery packs in the multi-battery pack system are simultaneously charged. Therefore, in the case that the battery pack having the minimum voltage and the battery pack having the second minimum voltage in the multi-battery pack system satisfy the predetermined charging condition, the method is capable of simultaneously charging both the two battery packs until all the battery packs are simultaneously charged. Compared with the traditional solution of sequentially charging the battery packs, the method shortens the charging time and improves the charging efficiency while implementing parallel mixed use of different battery packs.

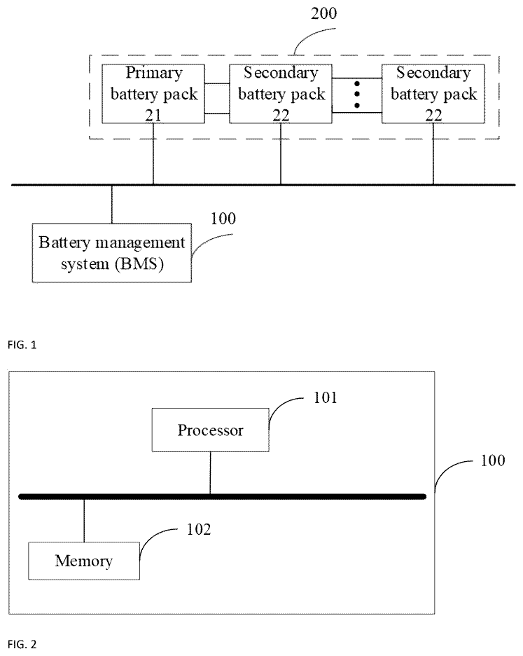

Referring to FIG. 2, the battery management system 100 may be provided with at least one processor 101 (FIG. 2 uses one processor as an example) and a memory 102 that are communicably connected via a bus or in other fashions.

The processor 101 is configured to provide calculation and control capabilities to control the battery management system to perform corresponding tasks. For example, the battery management system is controlled to perform any of parallel control methods for multiple battery packs according to embodiments hereinafter.

The memory 102, as a non-transitory computer readable storage medium, may be configured to store non-transitory software programs, non-transitory computer executable programs and modules, for example, the program instructions/modules corresponding to the parallel control method for multiple battery packs according to the embodiments hereinafter. The non-transitory software programs, instructions and modules stored in the memory 102, when executed, cause the processor 101 to perform the parallel control methods for multiple battery packs according to any one of the method embodiments hereinafter. Specifically, the memory 102 may include a high-speed random access memory, or include a non-transitory memory, for example, at least one disk storage device, a flash memory device, or another non-transitory solid storage device.

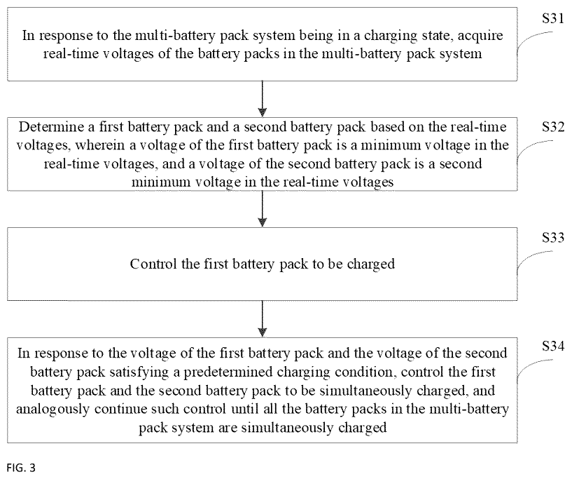

FIG. 3 is a schematic flowchart of a parallel control method 300 for multiple battery packs according to an embodiment of the present disclosure. The method may be performed by any type of battery management system, for example, the battery management system as illustrated in FIG. 1.

Specifically, referring to FIG. 3, the method S300 may include, but is not limited to, the following steps.

In S31, in response to the multi-battery pack system being in a charging state, real-time voltages of the battery packs in the multi-battery pack system are acquired.

The battery packs in the multi-battery pack system may be connected in parallel via a high-voltage wire harness to form a high-voltage discharging loop and a high-voltage charging loop, and an input power source (for example, a charger) charges the battery packs via the high-voltage charging loop, and the battery packs supply power to a load via the high-voltage discharging loop. Each battery pack includes n cells. Each cell has a cell reference voltage, a cell real-time voltage, and the like cell parameters. A total voltage of the n cells is the voltage of the battery pack. Therefore, the real-time voltage of each battery pack is the real-time total voltage of the n cells.

Before the method is performed, a state of the multi-battery pack system needs to be determined. Specifically, the multi-battery pack system includes a primary battery pack and a plurality of secondary battery packs. When a new secondary battery pack is inserted to the multi-battery pack system, the new secondary battery pack is first identified. In response to successful identification, whether a charging current is input to the primary battery pack in the multi-battery pack system is determined. In the case that a charging current is input to the primary battery pack, it is determined that the multi-battery pack system is in a charging state, and otherwise, it is determined that the multi-battery pack system is in a discharging state.

When the new battery pack is inserted to the multi-battery pack system, the multi-battery pack system establishes a communication connection to the new secondary battery pack, and acquires such battery attributes as cell material, number of cells, manufacturer and the like. In the case that the battery attributes of the new secondary battery pack are the same as the battery attributes of the multi-battery pack system, it is determined that the new secondary battery pack is successfully identified.

Upon successful identification, the new secondary battery pack and the original multi-battery pack system form a new multi-battery pack system. Then, whether the new multi-battery pack system is in a charging state is determined by the above approach. In the case that the new multi-battery pack system is in a charging state, real-time voltages of the battery packs in the new multi-battery pack system are acquired.

In S32, a first battery pack and a second battery pack are determined based on the real-time voltages, wherein a voltage of the first battery pack is a minimum voltage in the real-time voltages, and a voltage of the second battery pack is a second minimum voltage in the real-time voltages.

The real-time voltages may be ranked in an ascending order by sequence numbers. The voltage corresponding to a first sequence number is the minimum voltage in the real-time voltages and the battery pack corresponding to the first sequence number is the first battery pack, and the voltage corresponding to a second sequence number is the second minimum voltage in the real-time voltages and the battery pack corresponding to the second sequence number is the second battery pack.

It should be noted that the first battery pack and the second battery pack are not fixed battery packs, and more than one first or second battery pack may be provided, which depends on the changes of the real-time voltages of the battery packs. For example, the multi-battery pack system includes a primary battery pack, a secondary battery pack 1, and a secondary battery pack 2. In the case that the voltage of the primary battery pack is greater than the voltage of the secondary battery pack 1 which is greater than the voltage of the secondary battery pack 2, the first battery pack is the secondary battery pack 2, and the secondary battery pack is the secondary battery pack 1. Upon charging, in the case that the voltage of the primary battery pack is greater than the voltage of the secondary battery pack 1 which is equal to the voltage of the secondary battery pack 2, the first battery pack is the secondary battery pack 1 and the secondary battery pack 2, and the second battery pack is the primary battery pack.

In S33, the first battery pack is controlled to be charged.

During charging of the first battery pack, all the charging loops and discharging loops in the multi-battery pack system are switched first, and then the charging loop of the first battery pack is closed, such that an external input power source charges the first battery pack.

In S34, in response to the voltage of the first battery pack and the voltage of the second battery pack satisfying a predetermined charging condition, the first battery pack and the second battery pack are controlled to be simultaneously charged, and such control is analogously continued until all the battery packs in the multi-battery pack system are simultaneously charged.

As the first battery pack is being charged, the voltage of the first battery pack progressively increases, and the voltage of the charged first battery pack is closer to the voltage of the second battery pack. In the case that the voltage of the first battery pack and the voltage of the second battery pack satisfy the predetermined charging condition, the first battery pack and the second battery pack are controlled to be simultaneously charged.

The predetermined charging condition may be defined according to actual needs. In the embodiments of the present disclosure, the predetermined charging condition may be defined according to a first difference between the voltage of the first batter pack and the voltage of the second battery pack. Specifically, the predetermined charging condition includes the first difference between the voltage of the first battery pack and the voltage of the second battery pack being less than or equal to a first predetermined threshold. The first predetermined threshold may be defined according to actual needs, which indicates a proximity of the voltage of the first battery pack to the voltage of the second battery pack.

Upon charging, the voltage of the first battery pack is substantially equal to the voltage of the second battery pack, then the process returns again to the step of acquiring the real-time voltages of the battery packs in the multi-battery pack system, and analogously such control is continued until the all the battery packs in the multi-battery pack system are simultaneously charged.

For example, the multi-battery pack system includes a primary battery pack, a secondary battery pack 1, and a secondary battery pack 2. In the case that the voltage of the primary battery pack is greater than the voltage of the secondary battery pack 1 which is greater than the voltage of the secondary battery pack 2, the first battery pack is the secondary battery pack 2, and the secondary battery pack is the secondary battery pack 1. In this case, the secondary battery pack 2 is controlled to be charged first, and upon charging, a first difference between the voltage of the secondary battery pack 2 and the voltage of the secondary battery pack 1 is less than or equal to the first predetermined threshold, which indicates that the voltage of the secondary battery pack 2 is substantially equal to the voltage of the secondary battery pack 1. Then, the secondary battery pack 2 and the secondary battery pack 1 are controlled to be simultaneously charged, and then the process returns to the steps of acquiring the real-time voltages of the battery packs in the multi-battery pack system. The voltage of the primary battery pack is greater than the voltage of the secondary battery pack 1 which is equal to the voltage of the secondary battery pack 2, and thus the first battery pack is the secondary battery pack 1 and the secondary battery pack 2, and the second battery pack is the primary battery pack. In this case, the secondary battery pack 1 and the secondary battery pack 2 are controlled to be simultaneously charged. In the case that the voltages of the secondary battery pack 1 and the secondary battery pack 2 is close to the voltage of the primary battery pack, the primary battery pack, the secondary battery pack 1, and the secondary battery pack 2 are controlled to be simultaneously charged.

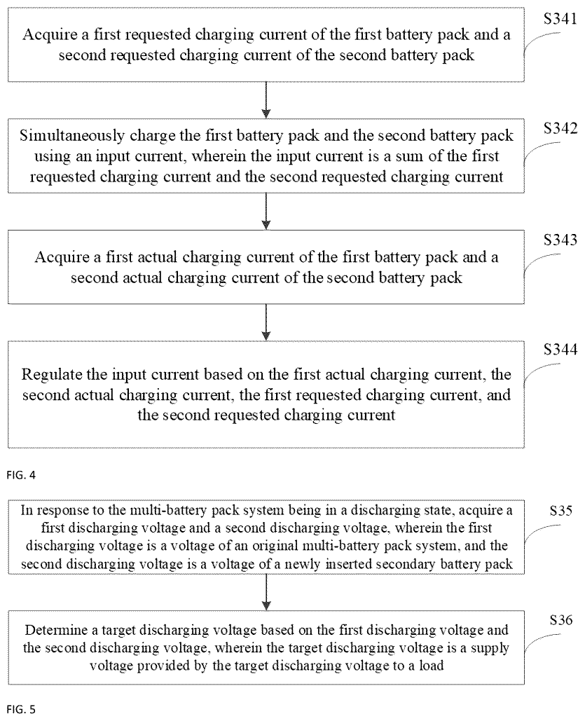

In the case that the first battery pack and the second battery pack are simultaneously charged, over current protection also needs to be performed for the first battery pack and the second battery pack, and actual charging currents need to be controlled for the first battery pack and the second battery pack to protect the first battery pack and the second battery pack from over current-induced damages. Specifically, as illustrated in FIG. 4, step S34 includes the following sub-steps.

In S341, a first requested charging current of the first battery pack and a second requested charging current of the second battery pack are acquired.

The first requested charging current and the second requested charging current are not fixed values, which are variable due to factors including, but not limited to, environment temperature, aging degrees of the battery packs, and the like. During the charging process, the battery management system acquires in real time the first requested charging current and the second requested charging current.

In S342, the first battery pack and the second battery pack are simultaneously charged using an input current, wherein the input current is a sum of the first requested charging current and the second requested charging current.

In S343, a first actual charging current of the first battery pack and a second actual charging current of the second battery pack are acquired.

The first battery pack and the second battery pack are simultaneously charged using the input current. However, the actual charging currents allocated to the first battery pack and the second battery pack are neither definite nor fixed values, but are determined according to the states of the battery packs. Therefore, during the charging process, the battery management system needs to acquire the first actual charging current and the second actual charging current.

In S344, the input current is regulated based on the first actual charging current, the second actual charging current, the first requested charging current, and the second requested charging current.

For over current protection, the battery management system needs to determine whether the first actual charging current, the second actual charging current, the first requested charging current, and the second requested charging current satisfy an over current protection condition. In the case that the over current protection condition is not satisfied, the input current is reduced.

The over current protection condition includes: the first actual charging current being less than or equal to the first requested charging current, and the second actual charging current being less than or equal to the second requested charging current.

That is, the input current is not regulated only in the case that the actual charging currents of the first battery pack and the second battery pack are both less than or equal to their respective requested charging currents. In the case that the actual charging current of one of the battery packs is greater than its requested charging current, it is characterized in that the battery pack is subjected to over current, and the input current is reduced such that the actual charging current of the battery pack is reduced.

Therefore, by the above approach for over current protection, the actual charging currents of the battery packs are prevented from being greater than their respective requested charging currents, such that over temperature, short circuit, decrease of effective capacities of the battery packs, or even premature wear-out of the battery packs are prevented.

It should be noted that in the case that the input current is reduced, the reduction amounts of the actual charging currents of the battery packs are not definite. The specific reduction amounts may be determined according to a ratio of the first requested charging current to the second requested charging current, or may be determined according to the states of the first battery pack and the second battery pack, or may be determined according to other parameters of the battery packs. Therefore, the specific values of the reduction amounts upon each regulation are not definite, and the battery management system needs to acquire in real time the first actual charging current and the second actual charging current upon regulation, and makes an judgment on the over current protection condition until the first actual charging current is less than or equal to the first requested charging current and the second actual charging current is less than or equal to the second requested charging current.

The regulation amount of the input current each time is not definite either, which may be determined according to an empirical value. In each regulation, the input current is reduced by a fixed change amount.

For example, in the case that the secondary battery pack 1 and the secondary battery pack 2 are simultaneously charged, respective requested charging currents and actual charging currents of the two secondary battery packs are as listed in Table 1.

TABLE 1
Values of requested charging current, actual
charging current, and input current

| | Secondary battery | | Secondary battery | |
|---|---|---|---|---|
| | pack 1 | | pack 2 | |
| Requested charging current | 2 | A | 1 | A |
| Actual charging current | 1.8 | A | 1.2 | A |

| | |
|---|---|
| Input current | 3 A |

As seen from Table 1, the actual charging current of the secondary battery pack 1 is 1.8 A which is less than the requested charging current, 2 A, of the secondary battery pack 1, and the actual charging current of the secondary battery pack 2 is 1.2 A which is less than the requested charging current, 1 A, of the secondary battery pack 2. In this case, over current-induced damages may be caused to the secondary battery pack 2, and thus the input current needs to be reduced. During regulation of the input current each time, the input current may be reduced according to the fixed change amount, for example, reduction by b A every a seconds (for example, reduction by 0.25 A every a seconds, upon a first reduction, a sum of currents is 3 A−0.25 A=2.75 A, and upon a second reduction, a sum of currents is 3 A−2*0.25 A=2.5 A). Using a scenario where the sum of currents upon the second reduction is 2.5 A as an example, in this case, the requested charging currents and actual charging currents of the secondary battery pack 1 and the secondary battery pack 2 are as listed in the following table.

TABLE 2
Values of requested charging current, actual charging
current, and a sum of actual charging currents

| | Secondary battery | | Secondary battery | |
|---|---|---|---|---|
| | pack 1 | | pack 2 | |
| Requested charging current | 2 | A | 1 | A |
| Actual charging current | 1.5 | A | 1 | A |

| | |
|---|---|
| Sum of actual charging currents | 2.5 A |

As listed in Table 2, the actual charging currents of the secondary battery pack 1 and the secondary battery pack 2 are both less than or equal to their respective requested charging currents, which prevents over current-induced damages to the battery packs.

In the above embodiments, the charging current of the multi-battery pack is controlled. In some embodiments, in simultaneously charging the first battery pack and the second battery pack, the charging voltage is also controlled. Specifically, a first requested charging voltage of the first battery pack and a second requested charging voltage of the second battery pack are acquired first, and then the first battery pack and the second battery pack are simultaneously charged using an input voltage, wherein the input voltage is a minimum voltage in the first requested charging voltage and the second requested charging voltage.

For example, the first requested charging voltage is 56 V, the second requested charging voltage 54.6 V, and the final input voltage is the minimum voltage 54.6 V of the two voltages. The first battery pack and the second battery pack are simultaneously charged using the voltage 54.6 V.

In summary, the parallel control method for multiple battery packs includes: in response to the multi-battery pack system being in a charging state, acquiring real-time voltages of the battery packs in the multi-battery pack system; determining a first battery pack and a second battery pack based on the real-time voltages, wherein a voltage of the first battery pack is a minimum voltage in the real-time voltages, and a voltage of the second battery pack is a second minimum voltage in the real-time voltages; controlling the first battery pack to be charged, and acquiring a voltage of the first battery pack upon charging; and in response to the voltage of the first battery pack and the voltage of the second battery pack satisfying a predetermined charging condition, controlling the first battery pack and the second battery pack to be simultaneously charged, and analogously continuing such control until the all the battery packs in the multi-battery pack system are simultaneously charged. Therefore, in the case that the battery pack having the minimum voltage and the battery pack having the second minimum voltage in the multi-battery pack system satisfy the predetermined charging condition, the method is capable of simultaneously charging both the two battery packs until all the battery packs are simultaneously charged. Compared with the traditional solution of sequentially charging the battery packs, the method shortens the charging time and improves the charging efficiency while achieving parallel mixed use of different battery packs.

After a new secondary battery pack is connected in parallel to an original battery pack system, in the case that the multi-battery pack system is in the discharging state, the discharging process of the multi-battery pack system needs to be controlled, such that circulating current is reduced under the premise of not interrupting power supply to the load, and current sharing control is achieved. Specifically, referring to FIG. 5, the method S300 further includes the following steps.

In S35, in response to the multi-battery pack system being in a discharging state, a first discharging voltage and a second discharging voltage are acquired, wherein the first discharging voltage is a voltage of an original multi-battery pack system, and the second discharging voltage is a voltage of a newly inserted secondary battery pack.

In the case that the new battery pack is not inserted to the system, the voltage of the original multi-battery pack system is the voltage of the multi-battery pack system. For example, in the case that the original multi-battery pack system includes the primary battery pack and the secondary battery pack 1, and the newly inserted secondary battery pack is the secondary battery pack 2, the original multi-battery pack system and the secondary battery pack 2 form a new multi-battery pack system. During insertion and parallel connection of the new battery pack, in the case that the multi-battery pack system is in the discharging state, the first discharging voltage corresponding to the primary battery pack and the secondary battery pack 2 and the second discharging voltage corresponding to the secondary battery pack 2 are acquired.

In S36, a target discharging voltage is determined based on the first discharging voltage and the second discharging voltage, wherein the target discharging voltage is a supply voltage provided by the target discharging voltage to a load.

The values of the first discharging voltage and the second discharging voltage may be different or equal. In the case that the values are different, in the course of parallel connection, circulating current may be caused in the multi-battery pack system, and damages are thus caused. Therefore, the target discharging voltage needs to be determined based on the first discharging voltage and the second discharging voltage, and circulating current under the premise of not interrupting power supply to the load.

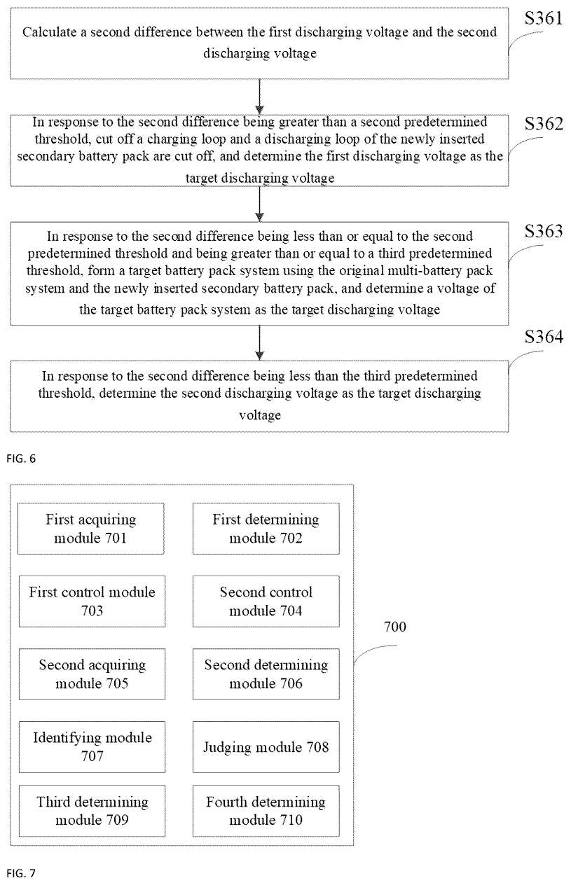

Specifically, as illustrated in FIG. 6, step S36 includes the following sub-steps.

In S361, a second difference between the first discharging voltage and the second discharging voltage is calculated.

In S362, in response to the second difference being greater than a second predetermined threshold, a charging loop and a discharging loop of the newly inserted secondary battery pack are cut off, and the first discharging voltage is determined as the target discharging voltage.

In the case that the second difference is greater than the second predetermined threshold, it indicates that a discharging voltage of the original multi-battery pack system is great, and thus the original multi-battery pack system still supplies power to the load.

However, to prevent circulating current caused by the original multi-battery pack system supplying power to the newly inserted secondary battery pack, the newly inserted secondary battery pack is first connected to the original multi-battery pack system, and then the charging loop of the newly inserted battery pack is switched. For continuous power supply by the original multi-battery pack system, the discharging loop of the newly inserted secondary battery pack is switched.

In the battery management system, connection of the newly inserted secondary battery pack, and closing and opening of the charging loop and the discharging loop are fulfilled by controlling a related switch transistor.

In S363, in response to the second difference being less than or equal to the second predetermined threshold and being greater than or equal to a third predetermined threshold, a target battery pack system is formed using the original multi-battery pack system and the newly inserted secondary battery pack, and a voltage of the target battery pack system is determined as the target discharging voltage.

In the case that the second difference is less than or equal to the second predetermined threshold and is greater than or equal to a third predetermined threshold, it indicates that the first discharging voltage is slightly different from the second discharging voltage, and thus the target battery pack system supplies power to the load.

The second predetermined threshold and the third predetermined threshold may be both defined according to actual needs, and the third predetermined threshold may be an opposite number of the second predetermined threshold.

In S364, in response to the second difference being less than the third predetermined threshold, the second discharging voltage is determined as the target discharging voltage.

In the case that the second difference is less than the third predetermined threshold, it indicates that a discharging voltage of the newly inserted secondary battery pack is great, and thus the second discharging voltage supplies power to the load.

To prevent circulating current caused by the newly inserted secondary battery pack supplying power to the original multi-battery pack system, the charging loop of the original multi-battery pack system is first cut off, then the newly inserted secondary battery pack is connected to the multi-battery pack system, and the discharging loop of the original multi-battery pack system is cut off, and finally the discharging loop of the newly inserted secondary battery pack is closed, such that the second discharging voltage supplies power to the load.

It should be noted that in steps S362 and S364, along with discharging, an eventual target discharging voltage is the voltage of the target battery pack system. That is, in the case that the first discharging voltage is slightly different from the second discharging voltage or is substantially equal to the second discharging voltage, the original multi-battery pack system and the newly inserted secondary battery pack collaboratively supply power to the load.

Therefore, each time a new secondary battery is inserted to the original multi-battery pack system, the parallel control method for the multi-battery pack system causes the battery pack having the maximum voltage to be discharged first, and along with discharging, further causes the newly inserted secondary battery pack and the original multi-battery pack system to collaboratively supply power to the load until all the batteries in the multi-battery pack system are exhaustively discharged. The method reduces circulating current while achieving parallel mixed use of different battery packs. In addition, in the method, neither restart upon power off nor re-determination on how to supply power is needed, and all the battery packs are ensured to be exhaustively discharged in a hot-swapping mode, thereby improving the discharging efficiency.

In summary, the parallel control method for multiple battery packs is capable of simultaneously charging the battery pack having the minimum voltage and the battery pack having the second minimum voltage until all the battery packs are simultaneously charged. Compared with the traditional solution of sequentially charging the battery packs, the method shortens the charging time and improves the charging efficiency while achieving parallel mixed use of different battery packs.

FIG. 7 is a schematic structural diagram of a parallel control apparatus 700 for battery packs according to an embodiment of the present disclosure. The parallel control apparatus 70 is applicable to a multi-battery pack system. Battery packs in the multi-battery pack system are connected in parallel. The parallel control apparatus 700 includes: a first acquiring module 701, a first determining module 702, a first control module 703, and a second control module 704.

The first acquiring module 701 is configured to, in response to the multi-battery pack system being in a charging state, acquire real-time voltages of the battery packs in the multi-battery pack system.

The first determining module 702 is configured to determine a first battery pack and a second battery pack based on the real-time voltages, wherein a voltage of the first battery pack is a minimum voltage in the real-time voltages, and a voltage of the second battery pack is a second minimum voltage in the real-time voltages.

The first control module 703 is configured to control the first battery pack to be charged.

The second control module 704 is configured to, in response to the voltage of the first battery pack and the voltage of the second battery pack satisfy a predetermined charging condition, control the first battery pack and the second battery pack to be simultaneously charged, and analogously continue such control until all the battery packs in the multi-battery pack system are simultaneously charged.

Therefore, in this embodiment, in the case that the multi-battery pack system is in the charging state, the parallel control apparatus for multiple battery packs is capable of simultaneously charging the battery pack having the minimum voltage and the battery pack having the second minimum voltage until all the battery packs are simultaneously charged. Compared with the traditional solution of sequentially charging the battery packs, the method shortens the charging time and improves the charging efficiency while achieving parallel mixed use of different battery packs.

In some embodiments, the predetermined charging condition includes:
a first difference between the voltage of the first battery pack and the voltage of the second battery pack being less than or equal to a first predetermined threshold.

In some embodiments, the second control module 704 is specifically configured to: acquire a first requested charging current of the first battery pack and a second requested charging current of the second battery pack; simultaneously charge the first battery pack and the second battery pack using an input current, wherein the input current is a sum of the first requested charging current and the second requested charging current; acquire a first actual charging current of the first battery pack and a second actual charging current of the second battery pack; and regulate the input current based on the first actual charging current, the second actual charging current, the first requested charging current, and the second requested charging current.

In some embodiments, regulating the input current based on the first actual charging current, the second actual charging current, the first requested charging current, and the second requested charging current includes:
determining whether the first actual charging current, the second actual charging current, the first requested charging current, and the second requested charging current satisfy an over current protection condition; and
reducing the input current in response to the over current protection condition being not satisfied.

In some embodiments, the over current protection condition includes:
the first actual charging current being less than or equal to the first requested charging current, and the second actual charging current being less than or equal to the second requested charging current.

In some embodiments, the second control module 704 is specifically configured to:
acquire a first requested charging voltage of the first battery pack and a second requested charging voltage of the second battery pack; and
simultaneously charge the first battery pack and the second battery pack using an input voltage, wherein the input voltage is a minimum voltage in the first requested charging voltage and the second requested charging voltage.

In some embodiments, the parallel control apparatus 700 further includes: a second acquiring module 705 and a second determining module 706.

The second acquiring module 705 is configured to, in response to the multi-battery pack system being in a discharging state, acquire a first discharging voltage and a second discharging voltage, wherein the first discharging voltage is a voltage of an original multi-battery pack system, and the second discharging voltage is a voltage of a newly inserted secondary battery pack.

The second determining module 706 is configured to determine a target discharging voltage based on the first discharging voltage and the second discharging voltage, wherein the target discharging voltage is a supply voltage provided by the target discharging voltage to a load.

In some embodiments, the second determining module 706 is specifically configured to:
calculate a second difference between the first discharging voltage and the second discharging voltage;
in response to the second difference being greater than a second predetermined threshold, cut off a charging loop and a discharging loop of the newly inserted secondary battery pack, and determine the first discharging voltage as the target discharging voltage;
in response to the second difference being less than or equal to the second predetermined threshold and being greater than or equal to a third predetermined threshold, form a target battery pack system using the original multi-battery pack system and the newly inserted secondary battery pack, and determine a voltage of the target battery pack system as the target discharging voltage; and
in response to the second difference being less than the third predetermined threshold, determine the second discharging voltage as the target discharging voltage.

In some embodiments, determining the second discharging voltage as the target discharging voltage includes:
cutting off a charging loop of the original multi-battery pack system;
connecting the newly inserted secondary battery pack to the system;
cutting off a discharging loop of the original multi-battery pack system; and
closing the discharging loop of the newly inserted secondary battery pack.

In some embodiments, the parallel control apparatus 700 further includes: an identifying module 707, a judging module 708, a third determining module 709, and a fourth determining module 710.

The identifying module 707 is configured to, in response to a new secondary battery packet being inserted to the multi-battery pack system, identify the newly inserted secondary battery pack.

The judging module 708 is configured to, in response to successful identification, determine whether a charging current is input to a primary battery pack in the multi-battery pack system.

The third determining module 709 is configured to determine that the multi-battery pack system is in a charging state in response to the charging current being input to the primary battery pack.

The fourth determining module 710 is configured to determine that the multi-battery pack system is in a discharging state in response to the charging current being not input to the primary battery pack.

It should be noted that since the parallel control apparatus for multiple battery packs and the parallel control method for multiple battery packs according to the above method embodiments are based on the same inventive concept, corresponding content disclosed the above method embodiments also apply to the apparatus embodiment, which is not described herein any further.

Therefore, in the case that the multi-battery pack system is in the charging state, the parallel control apparatus for multiple battery packs is capable of simultaneously charging the battery pack having the minimum voltage and the battery pack having the second minimum voltage until all the battery packs are simultaneously charged. Compared with the traditional solution of sequentially charging the battery packs, the method shortens the charging time and improves the charging efficiency while achieving parallel mixed use of different battery packs.

An embodiment of the present disclosure further provides a non-transitory computer-readable storage medium. The non-transitory computer-readable storage medium stores one or more computer-executable instructions. The one or more computer-executable instructions, when loaded and executed by one or more processors, for example, the processor 101 as illustrated in FIG. 2, cause the one or more processors to perform the parallel control method for multiple battery packs in any of the above embodiments.

An embodiment of the present disclosure provides a computer program product including a computer program stored in a non-transitory computer-readable storage medium. The computer program includes one or more program instructions. The one or more program instructions, when loaded and executed by a control unit, cause the control unit to perform the parallel control method for multiple battery packs in any of the above embodiments.

According to the above embodiments of the present disclosure, a person skilled in the art may clearly understand that the embodiments of the present disclosure may be implemented by means of hardware or by means of software plus a necessary general hardware platform. Persons of ordinary skill in the art may understand that all or part of the processes of the methods in the embodiments may be implemented by a computer program, instructing relevant hardware, in a computer program product. The computer program may be stored in a non-transitory computer-readable storage medium. The computer program includes program instructions, wherein the computer instructions, when loaded and executed by a drone, cause the drone to perform the processes of the method embodiments. The storage medium may be any medium capable of storing program codes, such as a magnetic disk, a compact disc read-only memory (CD-ROM), a read-only memory (ROM), a random-access memory (RAM), or the like.

The product may perform the parallel control methods for multiple battery packs according to the embodiments of the present disclosure, has corresponding function modules for performing the methods, and achieves the corresponding beneficial effects. For technical details that are not illustrated in detail in this embodiment, reference may be made to the description of the methods according to the embodiments of the present disclosure.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

1. A parallel control method for multiple battery packs, applicable to a multi-battery pack system, battery packs in the multi-battery pack system being connected in parallel, the method comprising:
in response to the multi-battery pack system being in a charging state, acquiring real-time voltages of the battery packs in the multi-battery pack system;
determining a first battery pack and a second battery pack based on the real-time voltages, wherein a voltage of the first battery pack is a minimum voltage in the real-time voltages, and a voltage of the second battery pack is a second minimum voltage in the real-time voltages;
controlling the first battery pack to be charged; and
in response to the voltage of the first battery pack and the voltage of the second battery pack satisfying a predetermined charging condition, controlling the first battery pack and the second battery pack to be simultaneously charged, and analogously continuing such control until the all the battery packs in the multi-battery pack system are simultaneously charged.

2. The method according to claim 1, wherein the predetermined condition comprises:
a first difference between the voltage of the first battery pack and the voltage of the second battery pack being less than or equal to a first predetermined threshold.

3. The method according to claim 1, wherein the step of controlling the first battery pack and the second battery pack to be simultaneously charged comprises:
acquiring a first requested charging current of the first battery pack and a second requested charging current of the second battery pack;
simultaneously charging the first battery pack and the second battery pack using an input current, wherein the input current is a sum of the first requested charging current and the second requested charging current;
acquiring a first actual charging current of the first battery pack and a second actual charging current of the second battery pack; and
regulating the input current based on the first actual charging current, the second actual charging current, the first requested charging current, and the second requested charging current.

4. The method according to claim 3, wherein the step of regulating the input current based on the first actual charging current, the second actual charging current, the first requested charging current, and the second requested charging current comprises:
determining whether the first actual charging current, the second actual charging current, the first requested charging current, and the second requested charging current satisfy an over current protection condition; and
reducing the input current in response to the over current protection condition being not satisfied.

5. The method according to claim 4, wherein the protection condition comprises:
the first actual charging current being less than or equal to the first requested charging current, and the second actual charging current being less than or equal to the second requested charging current.

6. The method according to claim 1, wherein the step of controlling the first battery pack and the second battery pack to be simultaneously charged comprises:
acquiring a first requested charging voltage of the first battery pack and a second requested charging voltage of the second battery pack; and
simultaneously charging the first battery pack and the second battery pack using an input voltage, wherein the input voltage is a minimum voltage in the first requested charging voltage and the second requested charging voltage.

7. The method according to claim 1, further comprising:
in response to the multi-battery pack system being in a discharging state, acquiring a first discharging voltage and a second discharging voltage, wherein the first discharging voltage is a voltage of an original multi-battery pack system, and the second discharging voltage is a voltage of a newly inserted secondary battery pack; and
determining a target discharging voltage based on the first discharging voltage and the second discharging voltage, wherein the target discharging voltage is a supply voltage provided by the target discharging voltage to a load.

8. The method according to claim 2, further comprising:
in response to the multi-battery pack system being in a discharging state, acquiring a first discharging voltage and a second discharging voltage, wherein the first discharging voltage is a voltage of an original multi-battery pack system, and the second discharging voltage is a voltage of a newly inserted secondary battery pack; and
determining a target discharging voltage based on the first discharging voltage and the second discharging voltage, wherein the target discharging voltage is a supply voltage provided by the target discharging voltage to a load.

9. The method according to claim 3, further comprising:
in response to the multi-battery pack system being in a discharging state, acquiring a first discharging voltage and a second discharging voltage, wherein the first discharging voltage is a voltage of an original multi-battery pack system, and the second discharging voltage is a voltage of a newly inserted secondary battery pack; and
determining a target discharging voltage based on the first discharging voltage and the second discharging voltage, wherein the target discharging voltage is a supply voltage provided by the target discharging voltage to a load.

10. The method according to claim 4, further comprising:
in response to the multi-battery pack system being in a discharging state, acquiring a first discharging voltage and a second discharging voltage, wherein the first discharging voltage is a voltage of an original multi-battery pack system, and the second discharging voltage is a voltage of a newly inserted secondary battery pack; and
determining a target discharging voltage based on the first discharging voltage and the second discharging voltage, wherein the target discharging voltage is a supply voltage provided by the target discharging voltage to a load.

11. The method according to claim 5, further comprising:
in response to the multi-battery pack system being in a discharging state, acquiring a first discharging voltage and a second discharging voltage, wherein the first discharging voltage is a voltage of an original multi-battery pack system, and the second discharging voltage is a voltage of a newly inserted secondary battery pack; and
determining a target discharging voltage based on the first discharging voltage and the second discharging voltage, wherein the target discharging voltage is a supply voltage provided by the target discharging voltage to a load.

12. The method according to claim 6, further comprising:
in response to the multi-battery pack system being in a discharging state, acquiring a first discharging voltage and a second discharging voltage, wherein the first discharging voltage is a voltage of an original multi-battery pack system, and the second discharging voltage is a voltage of a newly inserted secondary battery pack; and
determining a target discharging voltage based on the first discharging voltage and the second discharging voltage, wherein the target discharging voltage is a supply voltage provided by the target discharging voltage to a load.

13. The method according to claim 7, wherein the step of determining the target discharging voltage based on the first discharging voltage and the second discharging voltage comprises:
calculating a second difference between the first discharging voltage and the second discharging voltage;
in response to the second difference being greater than a second predetermined threshold, cutting off a charging loop and a discharging loop of the newly inserted secondary battery pack, and determining the first discharging voltage as the target discharging voltage;
in response to the second difference being less than or equal to the second predetermined threshold and being greater than or equal to a third predetermined threshold, forming a target battery pack system using the original multi-battery pack system and the newly inserted secondary battery pack, and determining a voltage of the target battery pack system as the target discharging voltage; and
in response to the second difference being less than the third predetermined threshold, determining the second discharging voltage as the target discharging voltage.

14. The method according to claim 13, wherein the step of determining the second discharging voltage as the target discharging voltage comprises:
cutting off a charging loop of the original multi-battery pack system;
connecting the newly inserted secondary battery pack to the system;
cutting off a discharging loop of the original multi-battery pack system; and
closing the discharging loop of the newly inserted secondary battery pack.

15. The method according to claim 1, further comprising:
in response to a new secondary battery packet being inserted to the multi-battery pack system, identifying the newly inserted secondary battery pack; and
in response to successful identification, determining whether a charging current is input to a primary battery pack in the multi-battery pack system;
determining that the multi-battery pack system is in a charging state in response to the charging current being input to the primary battery pack; and
determining that the multi-battery pack system is in a discharging state in response to the charging current being not input to the primary battery pack.

16. A battery management system, comprising:
at least one processor; and
a memory communicably connected to the at least one processor;
wherein the memory stores one or more instructions executable by the at least one processor, wherein the at least one processor, when loading and executing the one or more instructions, is caused to perform a parallel control method;
wherein the parallel control method comprises:
in response to the multi-battery pack system being in a charging state, acquiring real-time voltages of the battery packs in the multi-battery pack system;
determining a first battery pack and a second battery pack based on the real-time voltages, wherein a voltage of the first battery pack is a minimum voltage in the real-time voltages, and a voltage of the second battery pack is a second minimum voltage in the real-time voltages;
controlling the first battery pack to be charged; and
in response to the voltage of the first battery pack and the voltage of the second battery pack satisfying a predetermined charging condition, controlling the first battery pack and the second battery pack to be simultaneously charged, and analogously continuing such control until the all the battery packs in the multi-battery pack system are simultaneously charged.

17. The battery management system according to claim 16, wherein the predetermined condition comprises:
a first difference between the voltage of the first battery pack and the voltage of the second battery pack being less than or equal to a first predetermined threshold.

18. The battery management system according to claim 16, wherein the step of controlling the first battery pack and the second battery pack to be simultaneously charged comprises:
acquiring a first requested charging current of the first battery pack and a second requested charging current of the second battery pack;
simultaneously charging the first battery pack and the second battery pack using an input current, wherein the input current is a sum of the first requested charging current and the second requested charging current;
acquiring a first actual charging current of the first battery pack and a second actual charging current of the second battery pack; and
regulating the input current based on the first actual charging current, the second actual charging current, the first requested charging current, and the second requested charging current.

19. The battery management system according to claim 18, wherein the step of regulating the input current based on the first actual charging current, the second actual charging current, the first requested charging current, and the second requested charging current comprises:
determining whether the first actual charging current, the second actual charging current, the first requested charging current, and the second requested charging current satisfy an over current protection condition; and
reducing the input current in response to the over current protection condition being not satisfied.

20. A parallel control system for multiple battery packs, applicable to a multi-battery pack system, battery packs in the multi-battery pack system being connected in parallel, the system comprising:
at least one processor; and
a memory communicably connected to the at least one processor;
wherein the memory stores one or more instructions executable by the at least one processor, wherein the at least one processor, when loading and executing the one or more instructions, is caused to perform a parallel control method;
wherein the parallel control method comprises:
in response to the multi-battery pack system being in a charging state, acquiring real-time voltages of the battery packs in the multi-battery pack system;
determining a first battery pack and a second battery pack based on the real-time voltages, wherein a voltage of the first battery pack is a minimum voltage in the real-time voltages, and a voltage of the second battery pack is a second minimum voltage in the real-time voltages;
controlling the first battery pack to be charged; and
in response to the voltage of the first battery pack and the voltage of the second battery pack satisfying a predetermined charging condition, controlling the first battery pack and the second battery pack to be simultaneously charged, and analogously continuing such control until the all the battery packs in the multi-battery pack system are simultaneously charged.
